(19) United States
(12) Patent Application Publication
(10) Pub. No.: US 2013/0314556 A1
(43) Pub. Date: Nov. 28, 2013

(54) NETWORK CAMERA AND CONTROL METHOD THEREFOR

(71) Applicant: CANON KABUSHIKI KAISHA, Tokyo (JP)

(72) Inventor: Itaru Ikegami, Kawasaki-shi (JP)

(73) Assignee: CANON KABUSHIKI KAISHA, Tokyo (JP)

(21) Appl. No.: 13/902,358

(22) Filed: May 24, 2013

(30) Foreign Application Priority Data
May 28, 2012 (JP) 2012-121011

(51) Int. Cl. G06F 3/00

(52) U.S. Cl. CPC G06F 3/005
USPC 348/207.11

(57) ABSTRACT

A network camera includes a reception unit configured to receive a control request from a control side via a network, and a request unit configured to, in response to the reception unit receiving the control request, request a supply apparatus, which supplies power, to supply power to the network camera via the network.

### BACKGROUND OF THE INVENTION

1. Field of the Invention

The present invention relates to a network camera that operates on the power supplied from a network.

2. Description of the Related Art

Conventionally, there is a method, such as Power over Ethernet (PoE), that allows an apparatus connected to a communication cable of a communication network to receive power via the communication cable. Further, a universal serial bus (USB) device can draw power from a USB port. Unlike the power supply methods of commercial power sources and alternating current (AC) adapters, since the amount of power supplied via the communication cable is small, there is a known method that changes a drive method according to the method the power is supplied. For example, Japanese Patent Application Laid-Open No. 2009-153025 discusses a technique for changing the drive method of panning, tilting, and zooming depending on whether the power is supplied to the camera via an AC adapter or a USB cable.

According to the power supply method by the PoE, the power which can be used is determined when the network cable is connected. Thus, it is difficult to increase the receiving power during operation. Under such circumstances, Japanese Patent Application Laid-Open No. 2009-260563 discusses a method for increasing the receiving power by using a plurality of network cables. Further, in recent years, Institute of Electrical and Electronics Engineers (IEEE) 802.3at, which is a higher-level standard of conventional PoE standard IEEE 802.3af, is standardized. This standard allows power-receiving apparatuses to use greater power.

However, according to the above-described Japanese Patent Application Laid-Open No. 2009-153025, functions of the apparatus which can be used are limited since the operations vary depending on the power supply the apparatus is connected to. Thus, it is difficult to draw out the capability of the apparatus if the apparatus is continuously used. Further, according to the method discussed in Japanese Patent Application Laid-Open No. 2009-260563, since a plurality of cables are used by a single apparatus, the number of power-receiving apparatuses which can be connected to the hub is limited. Thus, it is difficult to practically use this method.

Further, since the conventional power-receiving method that requests supply of power to a PoE HUB is based on the maximum power consumption, the number of power-receiving apparatuses which can be connected to the hub is limited.

### SUMMARY OF THE INVENTION

The present invention relates to a network camera that can reduce power consumption while reducing operational constraints.

According to an aspect of the present invention, a network camera includes a reception unit configured to receive a control request via a network, and a request unit configured to, in response to the reception unit receiving the control request, request a supply apparatus, which supplies power, to supply power to the network camera via the network.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a network camera and an operation terminal connected via a PoE+Hub.

FIG. 2 is a block diagram illustrating a configuration example of the network camera.

FIG. 3 is a sequence diagram illustrating a case where power is requested.

FIGS. 4A and 4B are flowcharts illustrating processing performed by the network camera when a setup mode connection request is submitted from the operation terminal.

FIG. 5 illustrates an example of a selection table used for selecting actuators which can be driven at the same time.

FIG. 6 is a flowchart illustrating processing which is performed when an operation instruction including a request for power supply is provided from the operation terminal.

### DESCRIPTION OF THE EMBODIMENTS

Various exemplary embodiments, features, and aspects of the invention will be described in detail below with reference to the drawings.

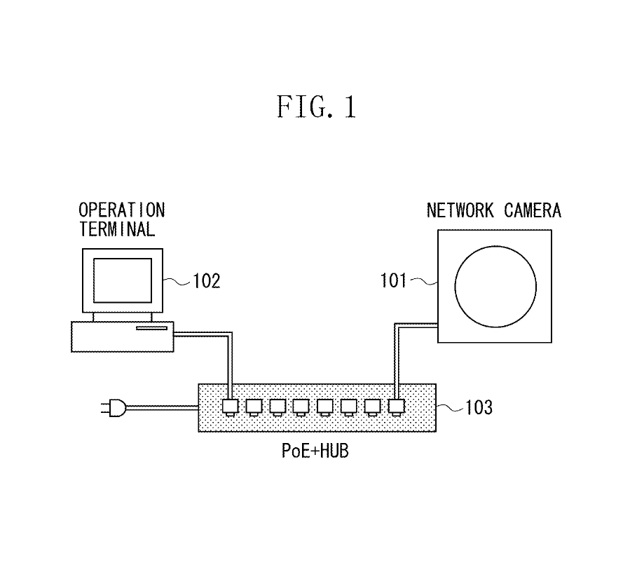

FIG. 1 illustrates a network camera 101, which operates on power provided via PoE, and an operation terminal 102 connected to a PoE+Hub 103, which supplies power to the network camera 101, according to an exemplary embodiment of the present invention. The PoE+Hub 103 supplies power to a network apparatus according to IEEE 802.3at. Further, a negotiation function regarding the power the PoE+Hub 103 supplies is provided to the PoE+Hub 103. According to the present exemplary embodiment, the network camera 101 operates solely on the PoE power supplied from the PoE+Hub 103. The network camera 101 according to the present embodiment has a power-receiving function of the power supplied from the PoE and a negotiation function regarding power consumption. Further, the network camera 101 is configured such that one or more actuators for panning, tilting, rotation, zooming, and focusing can be operated by the operation terminal 102 via the network.

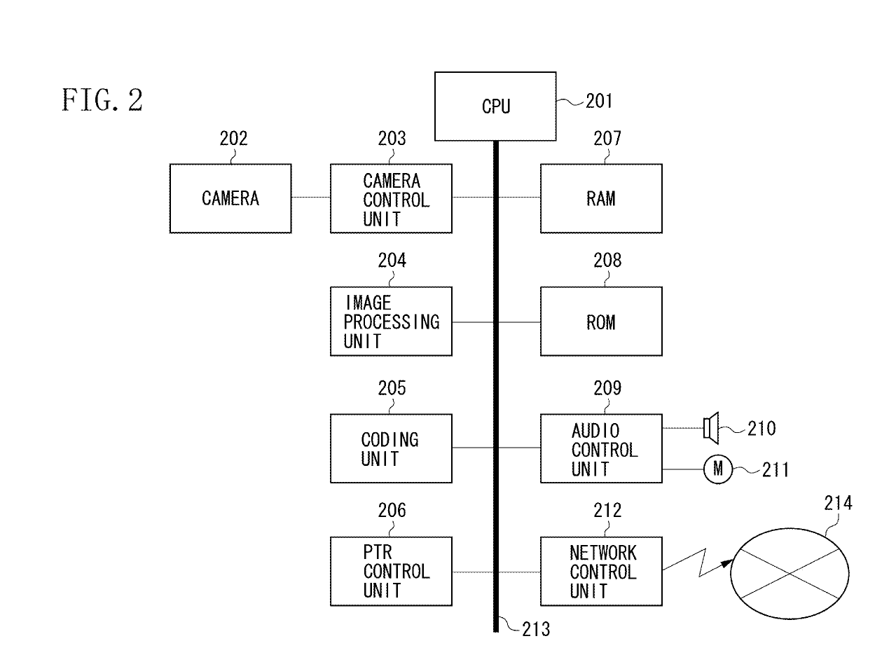

FIG. 2 is a block diagram illustrating an example of an inner configuration of the network camera 101.

In FIG. 2, a central processing unit (CPU) 201 controls the entire network camera 101. A camera 202 includes a lens, an image sensor, and a development processing unit. A camera control unit 203 controls the camera 202. The network camera can perform zooming and focusing by the camera control unit 203 controlling the camera 202.

An image processing unit 204 performs various types of correction processing on the video data obtained by the camera control unit 203. A coding unit 205 codes the video data. A panning/tilting/rotation (PTR) control unit 206 controls panning, tilting, and rotation. A random access memory (RAM) 207 temporary stores data necessary for the operation of programs and the video data coded by the coding unit 205. The programs which are used when the CPU 201 operates are loaded on the RAM 207 when they are executed. A read-only memory (ROM) 208, which is a flash memory, stores programs and files. Various settings are written and stored in the ROM 208. An audio control unit 209 controls a speaker 210 and a microphone 211, and records and reproduces audio data.

A network control unit 212 is connected to a network 214. To be more precise, the network control unit 212 is directly connected to the PoE+Hub 103 and communicates with the operation terminal 102. A bus 213 connects the CPU 201 and each unit.

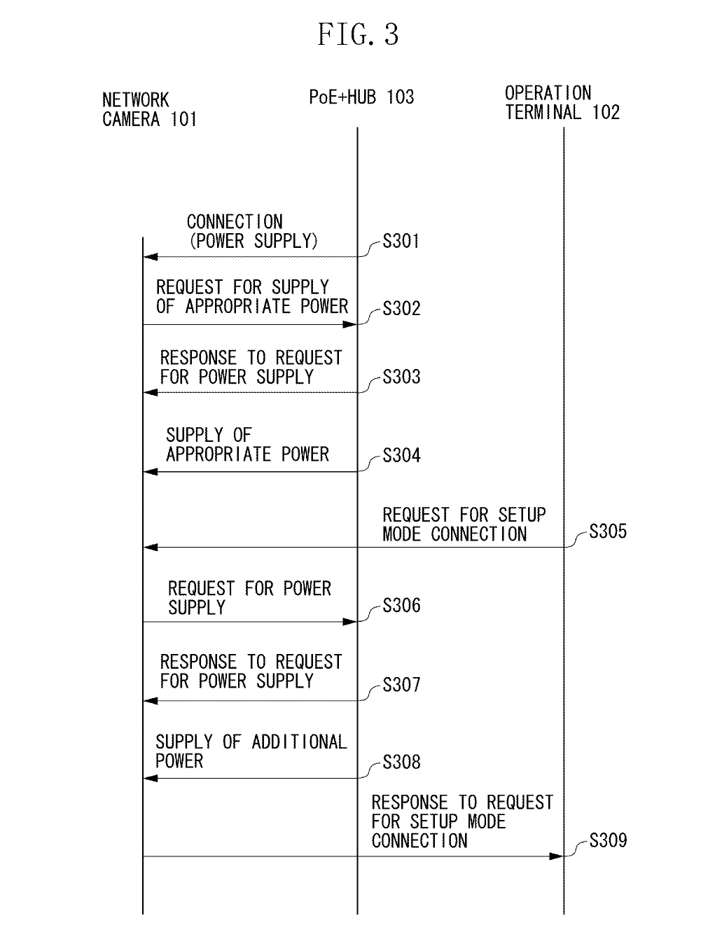

Next, processing procedures of the network camera 101, the operation terminal 102, and the PoE+Hub 103 according to a first exemplary embodiment of the present invention will be described with reference to FIG. 3.

In step S301, when the network camera 101 is connected to the PoE+Hub 103 via a network cable, the PoE+Hub 103 determines whether the connected apparatus is a PoE power-receiving apparatus that conforms to IEEE 802.3at. Then, the PoE+Hub 103 starts providing power.

The network camera 101 starts negotiation with the PoE+Hub 103 (steps S302 to S304), receives appropriate power to be used in video delivery, which is normal operation, and starts normal video delivery. To be more precise, during the negotiation, in step S302, the network camera 101 requests the PoE+Hub 103 to provide appropriate power. In response to the request, in step S303, the PoE+Hub 103 transmits a response to the request for power supply to the network camera 101, and, in step S304, the PoE+Hub 103 supplies appropriate power to the network camera 101.

In this state, in step S305, the network camera 101 receives a request for setup mode connection from the operation terminal 102. The setup mode is a mode of the network camera 101 that allows operation of one or more actuators of the network camera 101 selected from panning, tilting, rotation, zooming, and focusing. When the network camera 101 is in this mode, the imaging direction and the angle of view of the camera can be adjusted.

Normally, since the network camera 101 is used for monitoring purposes, the operation terminal 102 is not used for adjusting the camera direction but receives video data via the network 214. If the camera is newly set up, or if the camera needs adjustment to meet seasonal changes in daylight or changes in the monitoring area, the operation terminal 102 is connected to the network camera 101 in the setup mode. Then, the camera direction or the angle of view of the network camera 101 is adjusted according to instructions given by the operation terminal 102.

When the network camera 101 receives the request for setup mode connection from the operation terminal 102, then in step S306, the network camera 101 submits a request to the PoE+Hub 103 for power supply according to an operation instruction given by the operation terminal 102. The request for power supply is transmitted via a link layer of the Ethernet. On receiving the request, then in step S307, the PoE+Hub 103 calculates the power which can be supplied at that time, returns a response to the request for power supply to the network camera 101, and then in step S308, the PoE+Hub 103 supplies additional power to the network camera 101. The network camera 101 receives the response to the request for power supply in step S307, and then in step S309, the network camera 101 returns a response to the request for setup mode connection to the operation terminal 102.

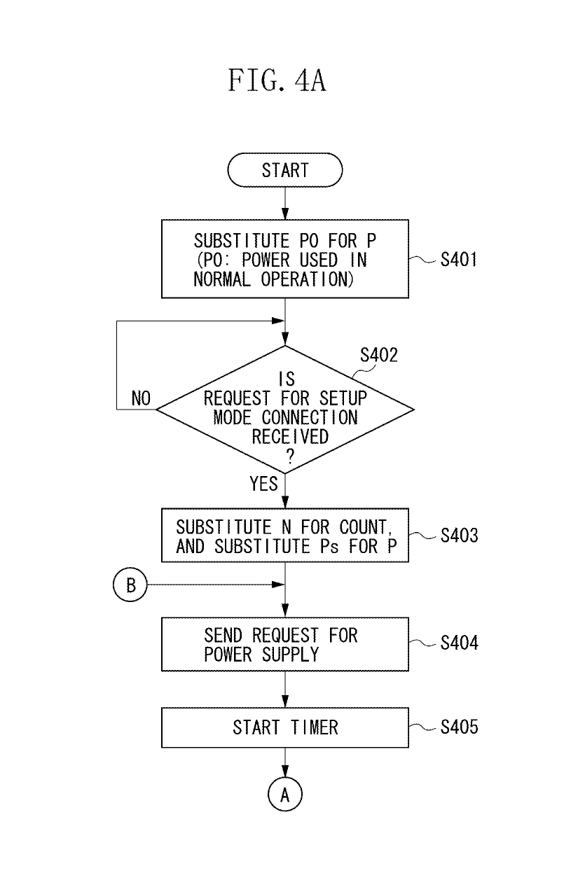

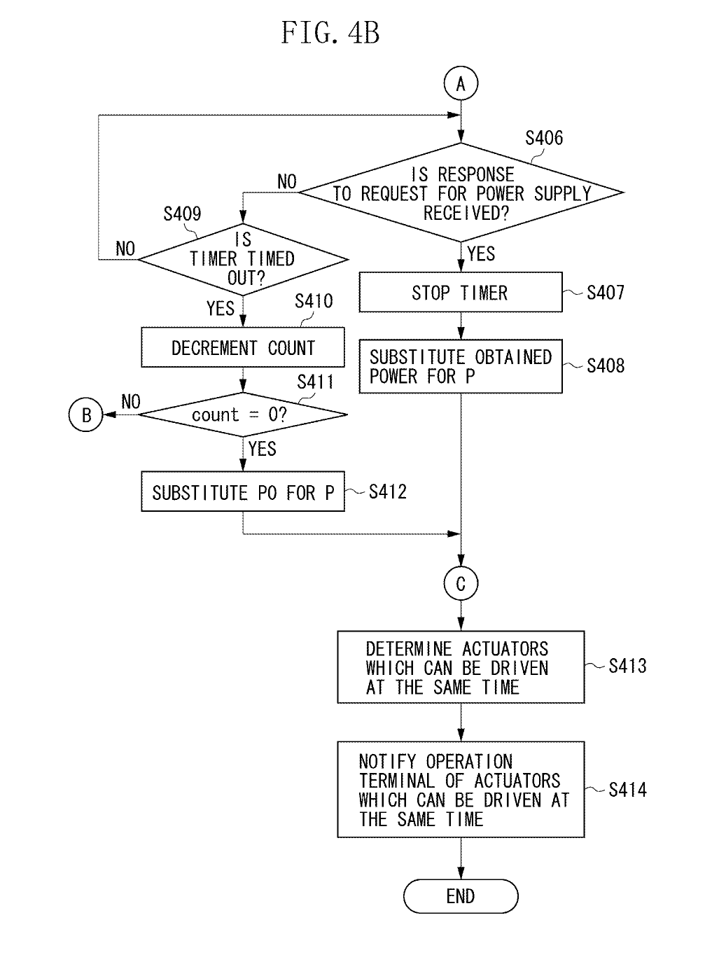

Next, the operation of the network camera 101 when the request for setup mode connection is submitted from the operation terminal 102 according to the first exemplary embodiment of the present invention will be described with reference to the flowchart in FIGS. 4A and 4B. The processing is realized by the CPU 201, as a computer, loading a program recorded in the ROM 208 into the RAM 207, which functions as a work memory, and executing it.

In step S401, the CPU 201 substitutes power PO for power P, where the power P is power which is used and the power P0 is power used in normal time. The power P0 is supplied from the PoE+Hub 103 in step S304 in FIG. 3. When the network camera 101 is connected to the PoE+Hub 103 (step S301 in FIG. 3), the network camera 101 requests the supply of power PO used in normal time of the PoE+ Hub 103 (step S302), and receives the power PO used in normal time (step S304).

In step S402, the CPU 201 determines whether the request for setup mode connection is received. If the request for setup mode connection is not yet received (NO in step S402), since the network camera 101 is operable by normal power, the power negotiation is not performed, and step S402 is repeated.

In step S402, if the CPU 201 determines that the request for setup mode connection is received (YES in step S402), the processing proceeds to step S403. In step S403, the CPU 201 substitutes N for “count” and further substitutes power Ps, which is the power to be used in the setup mode, for the power P. The “count” is the number of retry times. The request for setup mode connection is sent from the operation terminal 102 in step S305 in FIG. 3. According to the present exemplary embodiment, although the operation in the setup mode is described, if a mode other than the setup mode is used, a value other than N may be used for the number of retry times. The power used in the setup mode is power necessary for driving “panning, tilting, rotation” and “zooming and focusing”. The number of retry times N may be a predetermined value or a value set via a separate operation.

In step S404, the CPU 201 requests the PoE+Hub 103 to supply power. This request is the request for power supply sent by the network camera 101 in step S306 in FIG. 3. The power requested to the PoE+Hub 103 in step S404 is the power Ps to be used in the setup mode. In step S405, the CPU 201 starts a timer. The timer is used for determining whether the network camera 101 can receive a response from the PoE+Hub 103 within a predetermined time. A predetermined value may be used for the timer. However, an arbitrary value may be also set for the timer. In step S406, the CPU 201 determines whether the response to the request for power supply is received. This response is the response to the request for power supply returned from the PoE+Hub 103 in step S307 in FIG. 3. The response sent from the PoE+Hub 103 to the network camera 101 includes a value of the power which can be provided as a response to the request for the power Ps to be used in the setup mode.

In step S406, if the CPU 201 determines that the response is received (YES in step S406), the processing proceeds to step S407. In step S407, the CPU 201 stops the timer. In step S408, the CPU 201 substitutes the value of the obtained power, which is included in the received data, for the power P.

In step S406, if the response is not yet received (NO in step S406), the processing proceeds to step S409. In step S409, the CPU 201 determines whether the timer has timed out. If the timer has not yet timed out (NO in step S409), the processing returns to step S406, and the CPU 201 waits for the response. In step S409, if the CPU 201 determines that the timer has timed out (YES in step S409), the processing proceeds to step S410. In step S410, the CPU 201 decrements the count by 1. In step S411, the CPU 201 determines whether the count is 0.

If the count is not yet 0 (NO in step S411), the processing returns to step S404. In step S411, if the count is 0 (YES in step S411), since the number of retry times has reached the number set in advance, the processing proceeds to step S412. In step S412, the CPU 201 substitutes the power P0, which is the power originally assigned for the power P, and determines the usable power. In step S413, the CPU 201 determines the actuators to be driven at the same time.

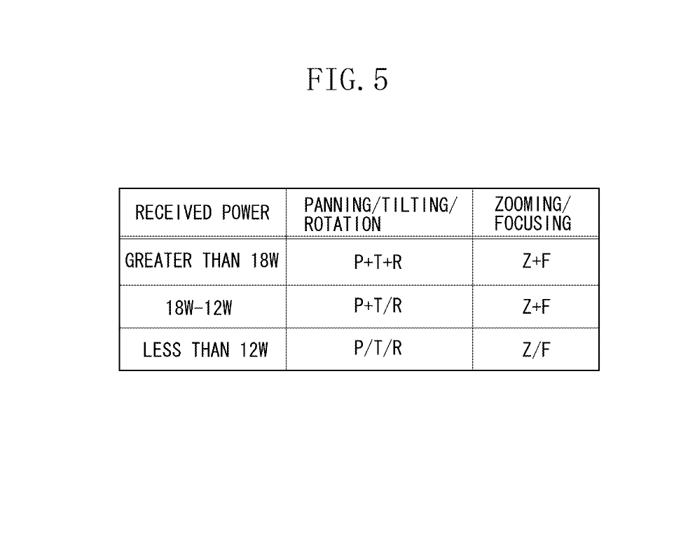

The determination of the actuators to be driven at the same time is described with reference to FIG. 5.

According to the present exemplary embodiment, the power obtained in step S408 (or the power P0 used in normal time and set in step S412) is classified into three types: greater than 18W, 18W to 12W, and less than 12W. If the obtained power is greater than 18W (in this case, the power is supplied as requested from the PoE+Hub 103), the actuators of panning, tilting, and rotation can be driven at the same time, and the actuators of zooming and focusing can also be driven at the same time. If the obtained power is 18W to 12W, the actuators of panning and tilting can be driven at the same time, and the actuators of zooming and focusing can also be driven at the same time. If the obtained power is less than 12W, only one actuator of panning, tilting, and rotation, and one actuator of zooming and focusing can be driven at the same time.

In step S414, after selecting the actuators which can be driven at the same time in step S413, the CPU 201 notifies the operation terminal 102 of the actuators, which can be driven at the same time, as a response to the request for setup mode connection. In other words, in response to the request for power supply according to the operation instruction sent from the operation terminal 102, if the power is supplied as requested, the actuators of panning, tilting, rotation, zooming, and focusing are driven at the same time. On the other hand, if the request for power supply is not satisfied, the CPU 201 notifies the operation terminal 102 that the actuators, which can be driven at the same time, will be selected from the actuators of panning, tilting, rotation, zooming, and focusing according to the power as is notified that the PoE+Hub 103 can supply, and that the selected actuators will be driven.

When the operation terminal 102 receives the information of the actuators which can be driven at the same time, the operation terminal 102 changes the operation screen according to the content of the received information. For example, if the actuators of zooming and focusing cannot be driven at the same time, the “zooming” button may be changed to a button for “angle of view adjustment” and displayed together with a “one-shot automatic focus (AF)” button. Alternatively, a message such as “operation is limited due to power limitation” may be displayed. In step S414, the CPU 201 sends a response to the request for setup mode connection to the operation terminal 102, and then the processing ends.

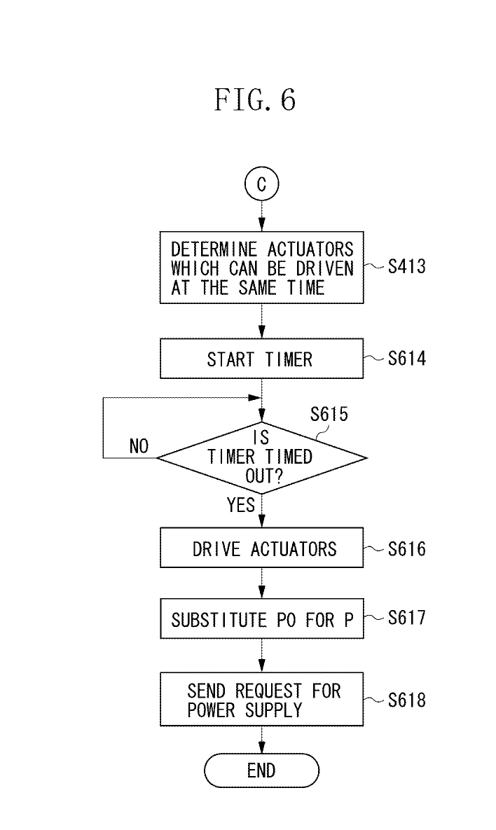

Next, the operation of the network camera 101 when an operation instruction including a request for power supply is given by the operation terminal according to a second exemplary embodiment of the present invention will be described with reference to FIGS. 4A and 4B, and 6. According to the first exemplary embodiment, the network camera 101 requests the PoE+Hub 103 to change the supply of power when the network camera 101 receives the request for setup mode connection. However, according to the second exemplary embodiment, the network camera 101 requests the PoE+Hub 103 to change the supply of power when the network camera 101 receives an actuator drive request. According to the second exemplary embodiment, the normal power of use is supplied from the PoE+Hub 103 to the network camera 101 before the network camera 101 receives the actuator drive request. The operation of the network camera 101 in receiving the actuator drive request is similar to the processing in steps S401 to S413 of the flowchart in FIGS. 4A and 4B except for step S402.

In step S402, the CPU 201 determines whether the actuator drive request is received. If the actuator drive request is not yet received (NO in step S402), since the network camera 101 is operable on normal power, the power negotiation is not performed, and step S402 is repeated. In step S402, if the CPU 201 determines that the actuator drive request is received (YES in step S402), the processing proceeds to step S403. In step S403, the CPU 201 substitutes N for “count” and further substitutes power Ps, which is the power to be used in an operation mode, for the power P. The “count” is the number of retry times.

A value other than N may be used for the number of retry times according to the type and combination of the drive-requested actuators. The number of retry times N may be a predetermined value or a value set via a separate operation. If a response to the request for power supply is not received within the time set by the timer started in step S405, the request for power supply is retried until the number of retry times reaches N. The timer that measures the time it takes to receive the request for power supply may be provided for each operation. Processing in steps S403 to S413 is as described above.

In step S614, after the CPU 201 determines the actuators which can be driven at the same time in step S413, the CPU 201 starts the timer. The timer is used for measuring the time from when the CPU 201 receives the response to the request for power supply sent from the PoE+Hub 103 to the time the power is actually supplied. The waiting time may be a predetermined value or changed according to the power P obtained in step S408. Further, the waiting time may be changed according to the difference of power between the power P0 and P. A timer is provided for each operation from when the request for power supply is submitted until a response to the request for power supply is received.

In step S615, the CPU 201 determines whether the timer has timed out. If the timer has not yet timed out (NO in step S615), step S615 is repeated. In step S615, if the CPU 201 determines that the time, which has been set, has elapsed (YES in step S615), the processing proceeds to step S616. In step S616, the CPU 201 drives the actuators which are determined in step S413 to be driven at the same time, and sequentially drives the actuators which cannot be driven at the same time.

In step S617, after the drive of all the actuators requested in step S402 is finished, the CPU 201 substitutes the power PO for the power P. In step S618, the CPU 201 transmits a request for power supply to the PoE+Hub 103. In the request, the requested power is set to the power PO being the normal power of use, and then the processing ends.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiments of the present invention, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-121011 filed May 28, 2012, which is hereby incorporated by reference herein in its entirety.

What is claimed is:

1. A network camera comprising:
a reception unit configured to receive a control request via a network; and
a request unit configured to, in response to the reception unit receiving the control request, request a supply apparatus, which supplies power, to supply power to the network camera via the network.

2. The network camera according to claim 1, wherein the request unit requests, in response to the reception unit receiving the control request, a supply apparatus, which supplies power by Power over Ethernet (PoE), to supply power to the network camera.

3. The network camera according to claim 1, wherein, if the reception unit receives a request for setting a mode for adjusting an imaging range, the request unit requests the supply apparatus to supply power to the network camera via the network.

4. The network camera according to claim 1, wherein the request unit requests the supply apparatus to supply power for changing an imaging direction via the network.

5. The network camera according to claim 1, wherein the request unit selects drive units, which are capable of being driven at the same time, from a plurality of drive units configured to change an imaging range, according to the power supplied from the supply apparatus.

6. The network camera according to claim 1, wherein the request unit notifies a sender of the control request of drive units which are capable of being driven at the same time and have been selected, out of a plurality of drive units configured to change an imaging range, according to the power supplied from the supply apparatus.

7. The network camera according to claim 1, wherein the request unit changes a screen of a sender of the control request according to the power supplied from the supply apparatus.

8. The network camera according to claim 1, wherein control according to a request corresponding to the control request is performed after an elapse of time according to the supplied power.

9. The network camera according to claim 1, wherein the request unit determines, according to an operation requested by the control request, a number of retry times in a case where a response to the request for power supply to the supply apparatus is not received.

10. A network camera comprising:
a changing unit configured to change an imaging range; and
a request unit configured to request a supply apparatus, which supplies power, to change supply of power via a network prior to the change in the imaging range by the changing unit.

11. The network camera according to claim 10, wherein the request unit requests, in response to a reception unit receiving a control request, a supply apparatus, which supplies power by Power over Ethernet (PoE), to supply power to the network camera.

12. A network camera comprising:
a changing unit configured to change an imaging range; and
a request unit configured to request a supply apparatus, which supplies power, to change supply of power via a network after completion of the change in the imaging range by the changing unit.

13. The network camera according to claim 12, wherein the request unit requests, in response to a reception unit receiving a control request, a supply apparatus, which supplies power by Power over Ethernet (PoE), to supply power to the network camera.

14. A method for controlling a network camera, the method comprising:
receiving a control request via a network; and
requesting, in response to reception of the control request, a supply apparatus, which supplies power, to supply power to the network camera via the network.

15. The method according to claim 14, further comprising requesting, in response to reception of the control request, a supply apparatus, which supplies power by Power over Ethernet (PoE), to supply power to the network camera.

16. The method according to claim 14, further comprising:
changing an imaging range according to the control request; and
requesting the supply apparatus, which supplies power, to change supply of power after completion of the change in the imaging range via the network.

17. A computer-readable storage medium storing a program that causes a computer to execute a method for controlling a network camera, the method comprising:
receiving a control request via a network; and
requesting, in response to reception of the control request, a supply apparatus, which supplies power, to supply power to the network camera via the network.

18. The computer-readable storage medium according to claim 17, wherein the method further comprises requesting, in response to reception of the control request, a supply apparatus, which supplies power by Power over Ethernet (PoE), to supply power to the network camera.

19. The computer-readable storage medium according to claim 17, wherein the method further comprises:
changing an imaging range according to the control request; and
requesting the supply apparatus, which supplies power, to change supply of power after completion of the change in the imaging range via the network.
